(19) United States
(12) Patent Application Publication
(10) Pub. No.: US 2005/0015727 A1
(43) Pub. Date: Jan. 20, 2005

(54) System with driving a peripheral device for downloading information over a communication network and method thereof

(75) Inventor: Tiffany Chen, Hsin-Chu (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: Mustek Systems Inc., Hsin-Chu (TW)

(21) Appl. No.: 10/876,765

(22) Filed: Jun. 28, 2004

Related U.S. Application Data
(63) Continuation-in-part of application No. 09/884,143, filed on Jun. 20, 2001, now abandoned.

(51) Int. Cl. G09G 5/00; G06F 3/00

(52) U.S. Cl. 715/748; 710/10; 710/8; 715/965

(57) ABSTRACT

A system with driving a peripheral device for downloading information over a communication network is installed into an electrical device, which includes a processing unit, an input unit, a display unit and a communication unit. The system has a driving and information-downloading module and a user interface module. Under the operation of the driving and information-downloading module, the electrical device can retrieve and download the information from a predetermined destination and drive a peripheral device, such as a scanner to scan under the command of the user at the same time.

### BACKGROUND OF THE INVENTION

1. Field of the Invention

This invention relates to a system with driving a peripheral device and method thereof, more particularly to a system with driving a peripheral device for downloading information over a communication network and method thereof.

2. Description of the Prior Art

Since the dramatic development and utilization of technologies in our daily life, now the computers have been employed in many ways, such as the document-processing, image-processing, going on the net and others. Sometimes, peripherals are needed to achieve such works. For examples, scanners, digital cameras and printers are very popular to be the proper peripheral devices.

Before users can use the peripheral devices, drivers are generally needed to be installed previously. After the installation of the drivers for the peripheral devices respectively, the peripheral devices are therefore controllable and useful. FIG. 1 shows the function block diagram of an electrical device such as a computer. A peripheral device 3 is connected to the electrical device 1. The peripheral device 3 is a scanner, a digital camera or a printer. The electrical device 1 includes a processing unit 10, an input unit 12 and a display unit 14. The input unit 12 could be a keyboard or a mouse for inputting purposes. The display unit 14 could be a CRT monitor or a LCD monitor for displaying the inputted data from the input unit 12. The processing unit 10 at least includes an interface module 101 and a driving module 103 that are a firmware. When the user installs the interface module 101 and the driving module 103 in the processing unit 10, the electrical device would have the functions performed by the interface module 101 and the driving module 103. The driving module 103 is for recognizing the peripheral device 3 and further for registering and controlling the recognized peripheral device 3. In this case, the peripheral device 3 is installed and connected to the electrical device 1. The interface module 101 provides a user interface displayed on the display unit 14 as shown in FIG. 2. The electrical device 1 further includes an operation system 20 such as MICROSOFT WINDOWS. The interface will therefore be displayed under the operation system 20. By inputting the data or adjusting parameters, the user can control the peripheral device 3 via the electrical device 1.

In view of the above, in case of the peripheral device is a scanner and the electrical device is a computer, the computer will recognize the scanner after the installation of the interface module 101 and the driving module 103. The user may call the interface module 101 for inputting or adjusting proper parameters. In this case, a user interface 30 is shown on the monitor 14 of the computer. The user interface contains a start button 301 and a preview window 303. The user may click the start button 301 after inputting proper parameters for controlling purposes, to begin scanning processes. Generally, this kind of operation to a scanner is widely known by present users.

However, due to convenience if the Internet, computer users would like to connect their computers to the Internet in order to enjoy the blooming information provided on the Internet. In this case, it would be great if the information or data would be downloaded to the computer automatically or manually during scanning and displayed on the user interface 30 of scanning rather than to search or open a browser software to review some specific information. Because the manufacturers of peripheral devices would provide some promotion with great price deal, or update the drivers sometimes, it would be welcome to the user if this kind of information would be downloaded to the computer. In this regard, the user would not need to spend time on researching and finding the promotion or update patches or drivers, nor open a browser to access specific web pages often.

### SUMMARY OF THE INVENTION

It is therefore an object of the present invention to provide a system with driving a peripheral device for downloading an information over a communication network and method thereof. The driving and information-downloading module is able to drive a peripheral device along with the ability for downloading messages. In this case, the manufacturer may actively provide information, such as the sale promotion, updated drivers or relative product data, directly to users. When users start the driving and information-downloading module, which will drive the peripheral device and download the relative information to users as well.

In view of the above and other objects which will become apparent as the description proceeds, there is provided according to a general aspect of the present invention a system with driving a peripheral device for downloading a information over a communication network installed into an electrical device, which includes a processing unit and a display unit, which comprises driving and information-downloading means for driving said peripheral device connected to said electrical device and downloading said information from a predetermined destination over said communication network; and user interface means for displaying a user interface on said display unit.

Based on the idea described above, said electrical device further comprising an input unit for inputting data to said electrical device.

Based on the aforementioned idea, said user interface further comprising a driving button for instructing said peripheral device to conduct.

Based on the idea described above, said electrical device further comprising a communication unit for connecting to said predetermined destination.

Based on the aforementioned idea, said driving and information-downloading means connects to said predetermined destination automatically after said user interface is started.

Based on the idea described above, said user interface further comprising an information-downloading button, located in said user interface, for initiating said driving and information-downloading means to retrieve said information to said electrical device.

Based on the aforementioned idea, said predetermined destination is an address of a web page.

Based on the idea described above, said electrical device comprises a storage device for storing said information.

Based on the aforementioned idea, said driving and information-downloading means displays said information on said display unit automatically.

Based on the idea described above, said user interface comprises an information-revealing button, placed on said user interface, for initiating said information shown in said display unit.

Based on the aforementioned idea, said driving and information-downloading means displays said information on an information area of said user interface.

Based on the idea described above, said driving and information-downloading means displays said information on an advertisement window.

Based on the aforementioned idea, said information includes a function of hypertext link.

Based on the idea described above, said information includes a function of hypertext link.

Based on the aforementioned idea, said electrical device is a computer.

Based on the idea described above, said peripheral device is a scanner.

Based on the aforementioned idea, said input unit is a keyboard.

Based on the idea described above, said input unit is a mouse.

In view of the above and other objects which will become apparent as the description proceeds, there is provided according to a general aspect of the present invention a method of driving a peripheral device and downloading a information over a communication network comprises the steps of opening a driving and information-downloading module, installed in an electrical device that includes a processing unit, an input unit and a display unit; opening a user interface module to generate a user interface displayed on said display unit; accessing a predetermined destination by said driving and information-downloading module for downloading said information; displaying said information on said display unit; and clicking a driving button placed in said user interface for instructing said driving and information-downloading module to drive a peripheral device.

Based on the idea described above, said step of opening a driving and information-downloading module further comprising a step of initiating an information-downloading button from said input unit.

Based on the aforementioned idea, said step of opening a user interface module further comprising a step of initiating an information-revealing button from said input unit.

Based on the idea described above, said predetermined destination is an address of a web page.

Based on the aforementioned idea, said information is shown on an information area of said user interface.

Based on the idea described above, said information is shown on an advertisement window.

Based on the aforementioned idea, said electrical device is a computer.

Based on the idea described above, said peripheral device is a scanner.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows the function block diagram of an electrical device that includes a prior known driving module;

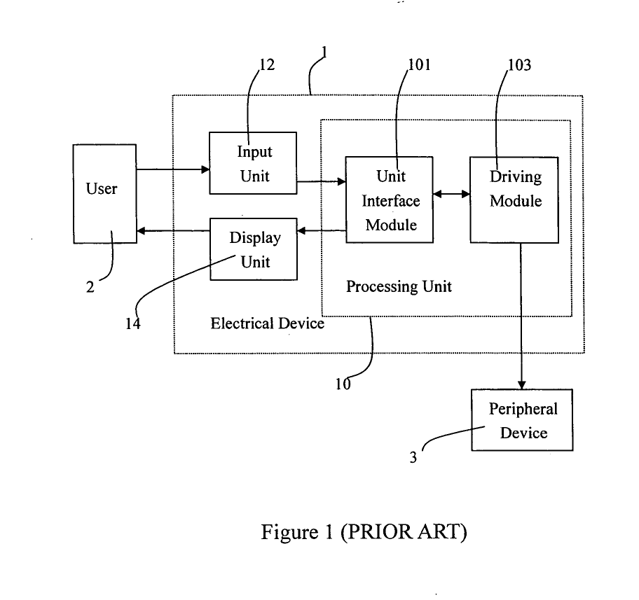

FIG. 2 demonstrates the display of the prior known user interface;

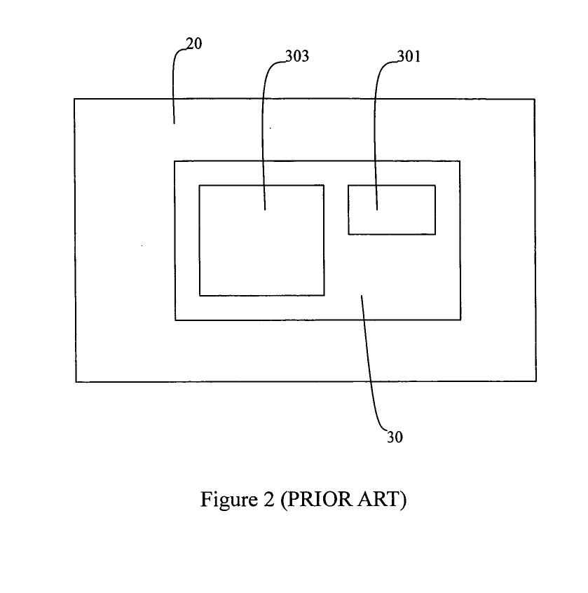

FIG. 3 shows the function block diagram of an electrical device that includes a driving and information-downloading module according to the present invention;

FIG. 4 demonstrates the display of the user interface according to the present invention; and

FIG. 5 demonstrates the other display of the user interface according to the present invention.

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

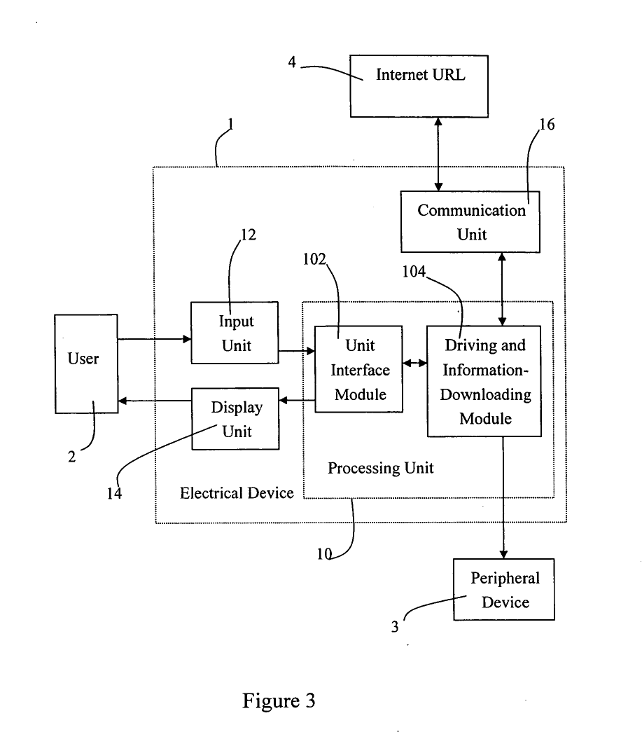

Please refer to FIG. 3. FIG. 3 shows the function block diagram demonstrating the electrical system with the driving and information-downloading module. The electrical device 1 connects a peripheral device 3. The peripheral device 3 could be a scanner, a digital camera or a printer for this example. The electrical device 1 may be a computer. The electrical device 1 includes a processing unit 10, an input unit 12, a display unit 14 and a communication unit 16. The input unit 12 may be a keyboard (not shown) or a mouse (not shown) for inputting data or instructions from user 2. The display unit 14 is a CRT monitor (not shown) or a liquid crystal display monitor (not shown) for displaying the information provided to the user 2. Further, the processing unit 10 contains at least a user interface module 102, and a driving and information-downloading module 104. The two modules are written by programmers and installed in the electrical device 1. After successful installation, the electrical device 1 would have the ability to conduct the functions specified of the two modules. For instance, the electrical device 1 with installed driving and information-downloading module 104 would recognize the peripheral device 3.

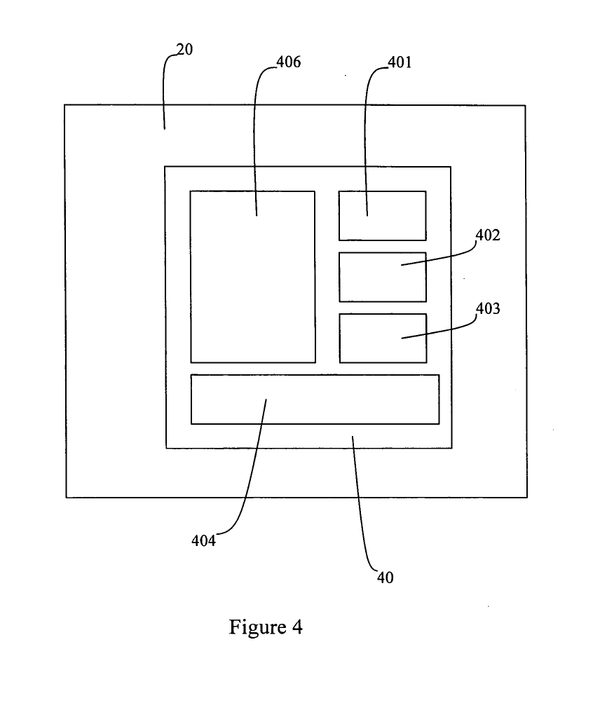

The user interface module 102 provides a user interface 40 shown on the display unit 14 as shown in FIG. 4. The electrical device 1 also includes an operation system 20 having an interface shown on the display unit 14. The user interface 40 is therefore operated under the operation system 20. Under the user interface 40, there are a driving button 401, an information-downloading button 402, an information-revealing button 403, an information area 404 and a preview window 406. When the user presses the driving button 401, the peripheral device 3 will be activated and operated. The user may preview the result in the preview window 406 and read the information, such as promotion or advertisement provided by the manufacturer, regarded to the peripheral device 3 at the same time.

When the user presses the information-downloading button 402, the driving and information-downloading module 104 will connect a specific location for downloading a specific information. The specific location is a specific data storage or a specific Internet URL 4 (Uniform Resource Locator). If the specific location is the URL, the driving and information-downloading module 104 will connect the URL via the communication module 16. The URL is included in the driving and information-downloading module 104, the URL addresses may be the addresses of web sites of the manufacturer, dealers, agents or other related information providers. For example, the manufacturers have to place a specific information on the specific Internet address for the driving and information-downloading module 104 to retrieve. When the specific information is retrieved by the driving and information-downloading module 104, the specific information will be downloaded and stored in s storage of the electrical device 1 (the storage is not shown in the Figure), or the information on the specific address will still be kept over the internet for further needs to download newly updated information. On the other concern, there could be no information-downloading button 402. In this case, when the user opens the user interface 40, the driving and information-downloading module 104 will automatically connect the URL 4 through the communication unit 16 for downloading a specific information over a communication network.

When the user clicks the information-revealing button 403, the display unit 104 will display the downloaded information in the information area 404. The demonstration method of the information area 404 would be similar to the well-known HTML (Hyper Text Markup Language) and the browsing program application would be similar to the well-known browsers such as the Explorer or the Navigator. In this case, the information area will be able to show the texts, images, sounds, movies, clips with Flash supported. Besides, the support of Hyperlink function enables the user to access the web site when the user clicks the advertisement. In this case, the downloaded information will not be limited to the driving and information-downloading module 104 but be expanded to the other browsers such as the Explorer or the navigator. On the other hand, the user interface 40 can be developed to a window without the information-revealing button 403. So that the display unit 104 will connect to the specific web site or the advertisement information previously stored in the storage (not shown) of the electrical device 1 when the user starts the user interface 40. Thus, the advertising information will be shown in the information area 404 automatically.

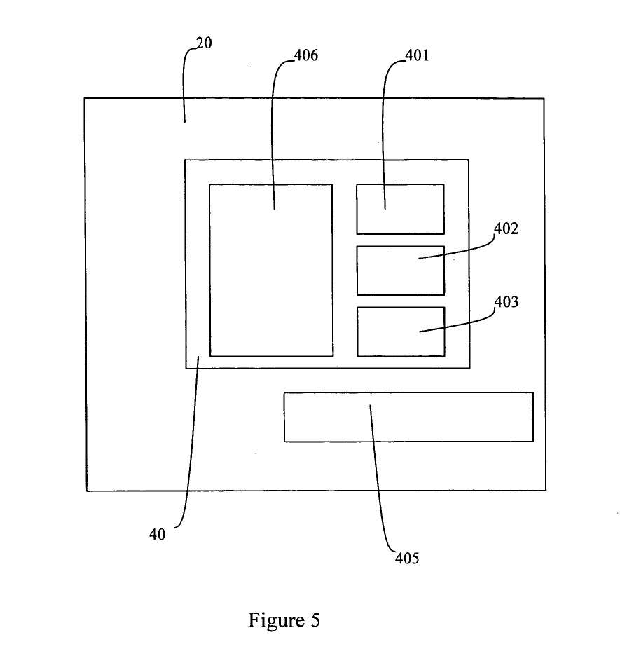

FIG. 5 shows another design of the information area 404. An independent advertisement window 405 is separated from the user interface 40. In this case, the user will not see the advertisement information when the user does not click the information-revealing button 403. The advertisement windows 405 will be opened only when the user clicks the information-revealing button 403.

As discussed in the above, the driving and information-downloading module of the present invention not only serve the ordinary functions of a driving module, but also serve the functions of downloading advertisements or promotions. The advertisement information can be first downloaded to the storage of the electrical device for later reviewing or accessed via a browser. For instance, the employment of the driving and information-downloading module of the present invention will enable the manufactures of scanners to provide the services, promotions, advertisements, update information or drivers at user's finger tips, rather than to search the known destination on the Internet. In the way, the user can obtain the information from a specific information provider when the user conducts scanning. A detailed method of the foregoing is illustrated as follows:
1) The user starts the driving and information-downloading module from the command panel of the operation system. Then, the user interface module displays the user interface on the monitor;
2) When the user clicks the information-revealing button or the user interface is opened, the driving and information-downloading module will download automatically an advertisement or specific information from a predetermined location on the Internet;
3) When the user clicks the information-revealing button, the downloaded information will be shown in an information area or an advertisement window; and
4) The user is able to conduct scanning processes during any time when the information is downloaded or displayed.

Although the specific embodiment has been illustrated and described, it will be obvious to those skilled in the art that various modifications may be made without departing from what is intended to be limited solely by the appended claims.

1. A system with driving a peripheral device for downloading a information over a communication network installed into an electrical device, which includes a processing unit and a display unit, comprising:
driving and information-downloading means for driving said peripheral device connected to said electrical device and downloading said information from a predetermined destination over said communication network; and
user interface means for displaying a user interface on said display unit.

2. The system according to claim 1, wherein said electrical device further comprising an input unit for inputting data to said electrical device.

3. The system according to claim 1, wherein said user interface further comprising a driving button for instructing said peripheral device to conduct.

4. The system according to claim 1, wherein said electrical device further comprising a communication unit for connecting to said predetermined destination.

5. The system according to claim 1, wherein said driving and information-downloading means connects to said predetermined destination automatically after said user interface is started.

6. The system according to claim 1, wherein said user interface further comprising an information-downloading button, located in said user interface, for initiating said driving and information-downloading means to retrieve said information to said electrical device.

7. The system according to claim 5, wherein said predetermined destination is an address of a web page.

8. The system according to claim 5, wherein said electrical device comprises a storage device for storing said information.

9. The system according to claim 1, wherein said driving and information-downloading means displays said information on said display unit automatically.

10. The system according to claim 1, wherein said user interface comprises an information-revealing button, placed on said user interface, for initiating said information shown in said display unit.

11. The system according to claim 10, wherein said driving and information-downloading means displays said information on an information area of said user interface.

12. The system according to claim 10, wherein said driving and information-downloading means displays said information on an advertisement window.

13. The system according to claim 11, wherein said information includes a function of hypertext link.

14. The system according to claim 12, wherein said information includes a function of hypertext link.

15. The system according to claim 1, wherein said electrical device is a computer.

16. The system according to claim 1, wherein said peripheral device is a scanner.

17. The system according to claim 2, wherein said input unit is a keyboard.

18. The system according to claim 2, wherein said input unit is a mouse.

19. A method of driving a peripheral device and downloading a information over a communication network comprising the steps of:
opening a driving and information-downloading module, installed in an electrical device that includes a processing unit, an input unit and a display unit;
opening a user interface module to generate a user interface displayed on said display unit;
accessing a predetermined destination by said driving and information-downloading module for downloading said information;
displaying said information on said display unit; and
clicking a driving button placed in said user interface for instructing said driving and information-downloading module to drive a peripheral device.

20. The method according to claim 19, wherein said step of opening a driving and information-downloading module further comprising a step of initiating an information-downloading button from said input unit.

21. The method according to claim 19, wherein said step of opening a user interface module further comprising a step of initiating an information-revealing button from said input unit.

22. The method according to claim 19, wherein said predetermined destination is an address of a web page.

23. The method according to claim 19, wherein said information is shown on an information area of said user interface.

24. The method according to claim 19, wherein said information is shown on an advertisement window.

25. The method according to claim 19, wherein said electrical device is a computer.

26. The method according to claim 19, wherein said peripheral device is a scanner.
